(19) United States
(12) Patent Application Publication
(10) Pub. No.: US 2017/0277311 A1
(43) Pub. Date: Sep. 28, 2017

(54) Asynchronous Interaction Handoff To System At Arbitrary Time

(71) Applicant: Microsoft Technology Licensing, LLC, Redmond, WA (US)

(72) Inventors: Nathan P. Pollock, Seattle, WA (US); Mark Lee Aldham, Seattle, WA (US); Lindsay Ann Kubasik, Seattle, WA (US); Anthony R. Young, Bellevue, WA (US); Peter B. Freiling, Seattle, WA (US); Jeffrey E. Stall, Kirkland, WA (US)

(73) Assignee: Microsoft Technology Licensing, LLC, Redmond, WA (US)

(21) Appl. No.: 15/196,697

(22) Filed: Jun. 29, 2016

Related U.S. Application Data
(60) Provisional application No. 62/313,584, filed on Mar. 25, 2016.

(51) Int. Cl. G06F 3/048; G06F 3/0487

(52) U.S. Cl. CPC G06F 3/048; G06F 3/0487

(57) ABSTRACT

User input that is part of a user interaction with a computing device is received by a system module. The system module notifies the application of the user input, and the application determines whether the application is to handle the user interaction or the whether the operating system is to handle the user interaction. For user interactions that the operating system is to handle, the application notifies the operating system to handle the user interaction. For the duration of the user interaction, the operating system then determines what changes to make to a display of data based on the user interaction and need not (and typically does not) notify the application of the user input. Thus, the application hands off the user interaction to the operating system.

### RELATED APPLICATIONS

This application claims priority under 35 U.S.C. Section 119(e) to U.S. Provisional Application No. 62/313,584, filed Mar. 25, 2016 and titled “Asynchronous Interaction Handoff To System At Arbitrary Time”, the entire disclosure of which is hereby incorporated by reference.

### BACKGROUND

As computing technology has advanced, various different techniques for interacting with computers have been developed. However, some interactions are managed by computers in a manner that can be slow and inefficient, leading to delays or lags in interactions and/or significant usage of computer resources (e.g., memory, processing power).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a user input to a computing device is received, the user input being part of a user interaction with the computing device. An indication of the user input is provided to an application on the computing device, and an indication that a system module is to handle the user interaction is received from the application at an arbitrary time during the first user interaction. In response to receipt of the indication that the system module is to handle the user interaction, the system module continues to receive user input for the user interaction, determines how to change a display of data by the computing device by the system module handling the user interaction rather than the application handling the user interaction, and controls a display of data based on the handling of the user interaction by the system module.

In accordance with one or more aspects, an application receives, from a system module, an indication of a user input to the computing device that is part of a user interaction with the computing device. The application determines, at an arbitrary time during or after the user interaction, whether to handoff the user interaction to the system module or to keep handling the user interaction. In response to determining to handoff the user interaction to the system module, an indication is provided to the system module that the system module is to handle the user interaction. In response to determining to keep handling the user interaction, a determination of how to change a display of data by the computing device based on the user input is made, and an indication of how to change the display of data is provided to the system module.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example environment in which the asynchronous interaction handoff to system at arbitrary time discussed herein can be used.

FIG. 2 illustrates an example system including an application and operating system in accordance with one or more embodiments.

FIGS. 3 and 4 illustrate example action flows using the techniques discussed herein.

FIGS. 5A and 5B are a flowchart illustrating an example process for asynchronous interaction handoff to system at arbitrary time as discussed herein in accordance with one or more embodiments.

FIG. 6 illustrates an example system that includes an example computing device that is representative of one or more systems and/or devices that may implement the various techniques described herein.

### DETAILED DESCRIPTION

Asynchronous interaction handoff to system at arbitrary time techniques are discussed herein. Generally, a computing device includes an operating system with asynchronous interaction handoff support. User input that is part of a user interaction with the computing device is received by the operating system. The user input can be provided in various manners, such as a pen, stylus, finger, mouse, etc. providing input to a touchscreen or other input device. The user input is part of a user interaction, such as a particular gesture (e.g., a pan or scroll gesture, a pinch or stretch gesture, a drag and drop gesture, and so forth). The operating system receives the user input and determines (e.g., based on the location on a screen or display) an application that is to be notified of the user input.

The operating system notifies the application of the user input, and the application determines whether the application or the operating system is to handle the user interaction. Handling a user interaction refers to determining what changes to make to a display of data based on the user interaction. For example, for a user interaction that is a pan gesture, handling of the user interaction refers to determining what changes to make to the display of data for the application in response to the pan gesture (e.g., based on the direction of the pan gesture). Handling a user interaction optionally also refers to performing other operations or functions based on the user input received as part of the user interaction.

For user interactions that the application handles, user input continues to be received by the operating system, which provides the user input to the application. The application determines what changes to make to a display of data based on the user input, and provides an indication of those changes to the operating system. The operating system then proceeds to display the changed data as appropriate.

For user interactions that the operating system is to handle, the application notifies the operating system to handle the user interaction. For the duration of the user interaction, the operating system then determines what changes to make to a display of data based on the user interaction and need not (and typically does not) notify the application of the user input. Thus, the application hands off the user interaction to the operating system (also referred to herein as handing off the user interaction to the system). The user interaction or user interaction handling is referred to as being asynchronous because once the user interaction is handed off to the operating system, the user interaction is being handled independently of what the application is doing. The application can determine to hand off the user interaction to the operating system at any arbitrary time during the user interaction or after the user interaction is over as desired by the application. For example, in the case of a very quick user interaction, the application might be slow enough that it does not make a decision to hand off the user interaction to the operating system until after the user interaction is completed.

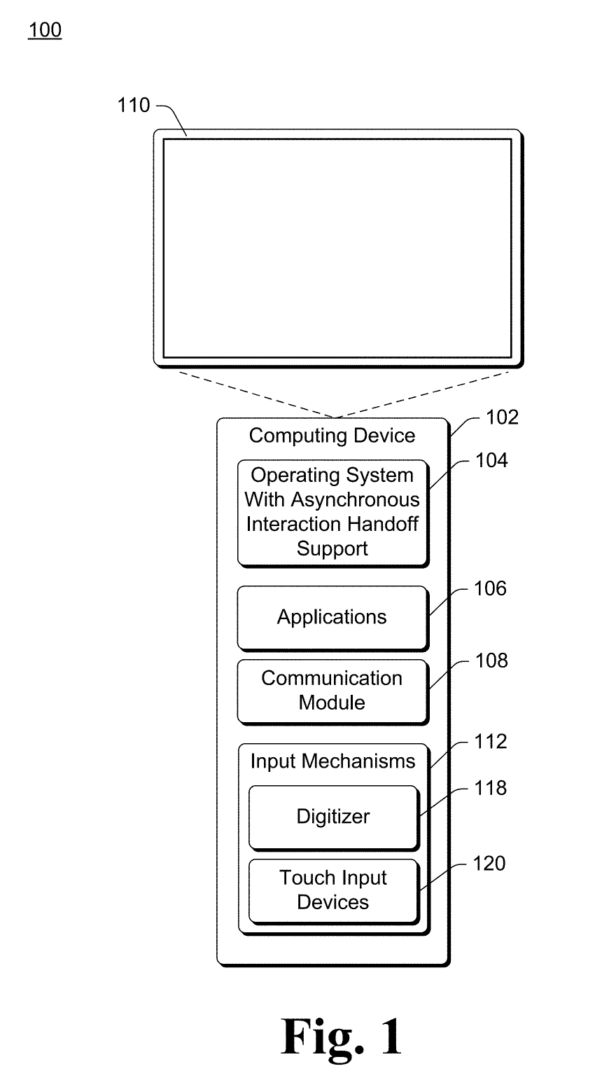

FIG. 1 illustrates an example environment 100 in which the asynchronous interaction handoff to system at arbitrary time discussed herein can be used. The environment 100 includes a computing device 102 that can be embodied as any suitable device such as, by way of example, a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet), an entertainment device (e.g., an entertainment appliance, a set-top box communicatively coupled to a display device, a game console), an Internet of Things (IoT) device (e.g., objects or things with software, firmware, and/or hardware to allow communication with other devices), a television or other display device, an automotive computer, and so forth. Thus, the computing device 102 may range from a full resource device with substantial memory and processor resources (e.g., personal computers, game consoles) to a low-resource device with limited memory and/or processing resources (e.g., traditional set-top boxes, hand-held game consoles).

The computing device 102 includes a variety of different functionalities that enable various activities and tasks to be performed. For instance, the computing device 102 includes an operating system with asynchronous interaction handoff support 104, multiple applications 106, and a communication module 108. Generally, the operating system 104 is representative of functionality for abstracting various system components of the computing device 102, such as hardware, kernel-level modules and services, and so forth. The operating system 104, for instance, can abstract various components of the computing device 102 to the applications 106 to enable interaction between the components and the applications 106.

The applications 106 represent functionalities for performing different tasks via the computing device 102. Examples of the applications 106 include a word processing application, an information gathering and/or note taking application, a spreadsheet application, a web browser, a gaming application, and so forth. The applications 106 may be installed locally on the computing device 102 to be executed via a local runtime environment, and/or may represent portals to remote functionality, such as cloud-based services, web apps, and so forth. Thus, the applications 106 may take a variety of forms, such as locally-executed code, portals to remotely hosted services, and so forth.

The communication module 108 is representative of functionality for enabling the computing device 102 to communicate over wired and/or wireless connections. For instance, the communication module 108 represents hardware and logic for communication via a variety of different wired and/or wireless technologies and protocols.

The computing device 102 further includes a display device 110 and input mechanisms 112. The display device 110 generally represents functionality for visual output for the computing device 102. Additionally, the display device 110 optionally represents functionality for receiving various types of input, such as touch input, pen input, and so forth. The input mechanisms 112 generally represent different functionalities for receiving input to the computing device 102. Examples of the input mechanisms 112 include gesture-sensitive sensors and devices (e.g., such as touch-based sensors and movement-tracking sensors (e.g., camera-based)), a mouse, a keyboard, a stylus, a touch pad, a game controller, accelerometers, a microphone with accompanying voice recognition software, and so forth. The input mechanisms 112 may be separate or integral with the display 110; integral examples include gesture-sensitive displays with integrated touch-sensitive or motion-sensitive sensors. The input mechanisms 112 optionally include a pen digitizer 118 and/or touch input devices 120. The pen digitizer 118 represents functionality for converting various types of input to the display device 110 and/or the touch input devices 120 into digital data that can be used by the computing device 102 in various ways, such as for generating digital ink, panning or zooming the display of data, and so forth. The touch input devices 120 represent functionality for providing touch input separately from the display 110.

Although reference is made herein to the display device 110 receiving various types of input such as touch input or pen input, alternatively the display device 110 may not receive such input. Rather, a separate input device (e.g., a touchpad) implemented as a touch input device 120 can receive such input. Additionally or alternatively, the display device 110 may not receive such input, but a pen (such as pen 122) can be implemented as a touch input device 120, and the pen provides an indication of the input rather than the input being sensed by the display device 110.

Input can be provided by the user in any of a variety of different manners. For example, input can be provided using an active pen that includes electronic components for interacting with the computing device 102 (e.g., a battery that can provide power to internal components of the pen 122, a magnet or other functionality that supports hover detection over the display device 110, etc.). By way of another example, input can be provided using a stylus without internal electronics, the user's finger, a mouse, audible inputs, hand or other body part motions (e.g., using a camera and/or skeletal tracking), and so forth.

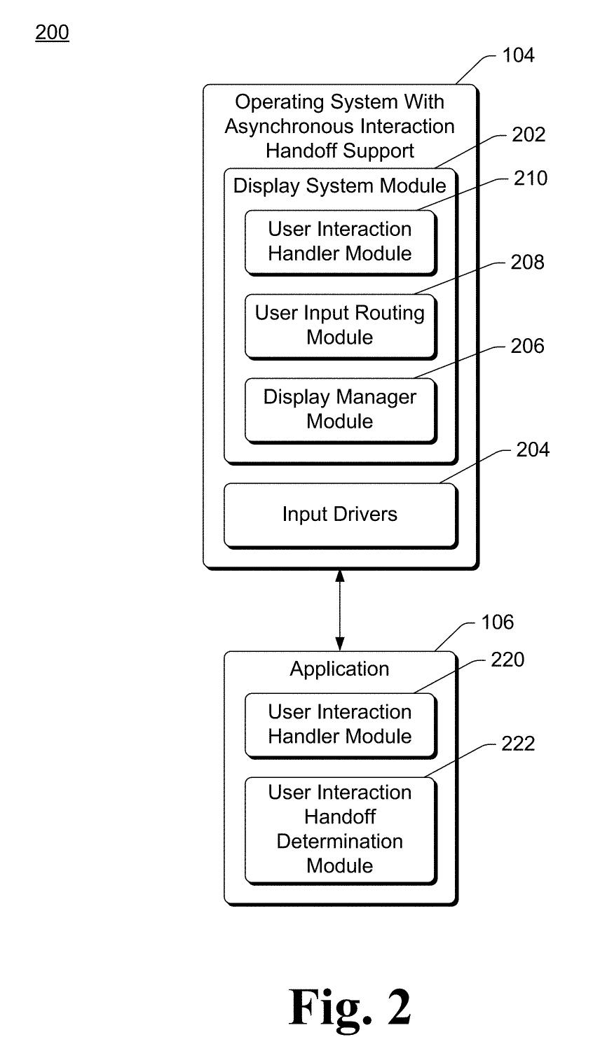

FIG. 2 illustrates an example system 200 including an application and operating system in accordance with one or more embodiments. FIG. 2 is discussed with reference to elements of FIG. 1. The operating system with asynchronous interaction handoff support 104 includes a display system module 202 and optionally one or more input drivers 204. Although illustrated as part of the operating system 104, at least part of the display system module 202 and/or at least part of the input drivers 204 can be implemented in other components or modules of the computing device 102 (e.g., as part of a basic input/output system (BIOS)). The display system module 202 is also referred to as a composition module or a compositor.

The display system module 202 includes a display manager module 206, a user input routing module 208, and a user interaction handler module 210. The display manager module 206 manages the display of data on a display or screen, such as the display 110. The data to be displayed can be determined and provided by the application 106 to the display system module 202 and/or can be determined and provided by the user interaction handler module 210.

The user input routing module 208 manages the routing of user input received by the display system module. User inputs received by the computing device 102 are analyzed by the user input routing module 208 to determine which program or application is responsible for handling or otherwise responding to the user interaction of which the user input is a part. The display system module 202 knows which locations for input (e.g., locations of a display) correspond to which applications or programs. For a given user input, the user input routing module 208 determines which application or program corresponds to the location of the user input (e.g., performs a hit test on the user input), and provides the user input to the corresponding application or program.

The user input refers to data representing the input by the user, such as a location touched or selected by the user, a timestamp at which a location is touched or selected (e.g., allowing a determination to be made of a motion or gesture performed by the user), audio data for an audible input command, and so forth. The user interaction refers to an operation, command, and/or function. The user interaction is made up of one or more user inputs. For example, a tap gesture (e.g., touching or clicking on an object) can include a single user input that is the location of a touchscreen or other input device touched by the user. By way of another example, a pan gesture (e.g., sliding a finger or other object across a touchscreen or other input device in a particular direction) can include multiple user inputs each of which is a location of a touchscreen or other input device touched by the user as the user slides his or her finger or other object across the touchscreen or other input device. In one or more embodiments, the user interaction is composed of three parts: an object down event (e.g., a finger or other object touching a touchscreen or other input device), an object up event (e.g., a finger or other objecting being lifted from or otherwise no longer touching a touchscreen or other input device), and an object movement that is movement of the object (or input device being controlled by the object) that occurs between the object down event and the object up event.

Any of a variety of different user interactions can be used with the techniques discussed herein. For example, the user interactions can be taps or click operations, scroll operations, drag and drop operations, pan operations, pinch-stretch operations, and so forth.

User inputs corresponding to the application 106 are provided by the display system module 202 to the application 106. The application 106 includes a user interaction handler module 220 and a user interaction handoff determination module 222. The user interaction handoff determination module 222 determines the user interaction corresponding to the user input and whether to handoff handling of the user interaction to the system (e.g., the display system module 202) or to maintain handling of the user interaction at the application 106. The user interaction handoff determination module 222 can determine the user interaction using any of a variety of different public and/or proprietary techniques, such as touch gesture determination techniques.

The user interaction handoff determination module 222 can determine whether to handoff handling of the user interaction to the display system module 202 in any of a variety of different manners. In one or more embodiments, the user interaction handoff determination module 222 maintains a list or record of which user interactions are to be handed off to the display system module (and/or a list or record of which user interactions are not to be handed off to the display system module but are to be handled by the user interaction handler module 220). Additionally or alternatively, various other rules or criteria can be applied to determine whether a user interaction is to be handed off to the display system module, such as what current operation or function is already being performed by the application 106, the location of the user input, the speed of movement of the user inputs, upcoming operations or functions to be performed by the application 106, and so forth.

In situations in which handling of the user interaction is to be maintained at the application 106, user inputs continue to be received by the application 106 from the display system module 202 and handling of the user interaction is performed by the user interaction handler module 220. The user interaction handler module 220 determines what changes to make to data displayed by the application 106 based on the user input, and provides an indication of that change to the display system module 202. This indication can be particular data to be displayed, a change in data displayed, and so forth. The display manager module 206 proceeds to make the change to the displayed data as indicated by the application 106.

In situations in which handling of the user interaction is handed off to the display system module 202, the user interaction handoff determination module 222 provides an indication to the display system module 202 that the user interaction is being handed off to the display system module 202. For the duration of the user interaction, the user input routing module 208 provides the user inputs to the user interaction handler module 210 rather than the user interaction handler module 220 of the application 106. For the duration of the user interaction, the application 106 need not (and typically does not) receive the user inputs.

The user interaction handler module 210 handles the user interaction. The user interaction handler module 210 has access to the data displayed by the application 106, and thus can determine changes to make to data displayed by the application 106 on its own rather than obtaining indications of such changes from the application 106. For example, the application 106 can provide or otherwise make available to the display system module 202 a data container identifying the data of the application 106 (e.g., a screen of data that can be displayed, although not necessarily all at once). The user interaction handler module 210 thus has ready access to the data in order to determine the changes to make based on the user interaction. By way of another example, the application 106 can provide or otherwise make available to the display system module 202 a data structure that describes a large area of visual data that has been set up by the application 106, and the user interaction handler module 210 can access the data structure to determine what portion of the visual data is displayed based on the user input.

The user interaction handler module 210 continues to handle the user interaction for the duration of the user interaction. After the user interaction is completed, the next user input (e.g., the beginning of the next user interaction) is provided to the application 106 and the user interaction handoff determination module 222 determines whether to hand off that next user interaction to the display system module 202 or to have handling of that next user interaction handled by the user interaction handler module 220 of the application 106. In one or more embodiments, the user input routing module 208 maintains a record (e.g., a flag) indicating whether the current user interaction for the application 106 is being handled by the user interaction handler module 210, and thus readily knows whether to route the user input to the user interaction handler module 210 or the application 106. This record can be updated (e.g., the flag cleared) when the current user interaction for the application 106 is completed. Different records can optionally be maintained for different user interactions, so the display system module 202 can be handling the current user interaction for one application 106 but not another application 106.

The completion of a user interaction can be determined in a variety of different manners. In one or more embodiments, the user interaction is completed when an input device is no longer sensed as providing input to the computing device 102 (e.g., a user lifts his or her finger away from a touchscreen, an active pen is no longer sensed to be close to (e.g., within a threshold distance of) a touchscreen or other input device). Additionally or alternatively, other techniques can be used to determine the completion of a user interaction. For example, a user interaction may have a restricted or limited amount of user input and the user interaction is completed when that amount of user input has been received (e.g., a gesture that is sliding a finger for no more than one inch, and after user input indicating the finer sliding across the touchscreen or other input device for one inch the user interaction is completed). By way of another example, the user interaction is completed when an input device is no longer sensed as providing input to the computing device 102 and the side effects of the user input have completed (e.g., if the user interaction was a flick gesture that started a list scrolling, the user interaction is completed when the input device is no longer sensed as providing input to the computing device 102 and the list has stopped scrolling). By way of yet another example, the user interaction is completed when the user interaction changes. For example, the application 106 may hand off a user interaction that the application 106 expects to be one category of user interaction (e.g., a scroll), but the user interaction may actually be a different category of user interaction that the display system module 202 does not understand (and thus ends the user interaction that the display system module 202 thought was being input, so providing of user input to the application resumes).

In one or more embodiments, the display system module 202 buffers user input it provides to the application 106. Thus, if the application 106 hands off handling of the current user interaction to the display system module 202, the display system module 202 has the user input already received for the current user interaction and can proceed to handle the user interaction as appropriate given the buffered user input.

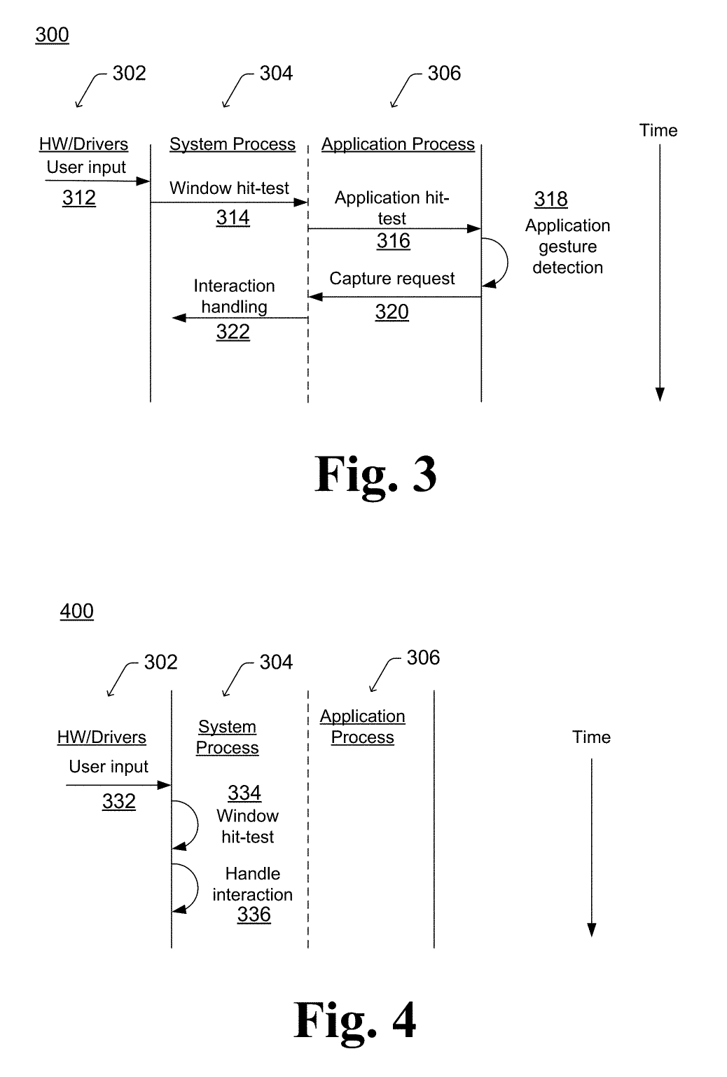

FIG. 3 illustrates an example action flow 300 using the techniques discussed herein. The flow 300 includes actions performed by the hardware and/or input drivers 302, such as a touchscreen or other input device, input drivers 204, and so forth. The flow 300 also includes actions performed by a system process 304, such as by the display system module 202. The flow also includes actions performed by an application process 306, such as the application 106.

The hardware and/or drivers 302 receive user input 312. The user input 312 is provided to the system process 304, which performs a system hit test 314 on the user input. The system hit test 314 determines which application the user input corresponds to (e.g., which window was touched or is currently the active window). The user input 312 is provided to the application process 306, which performs an application hit test 316 on the user input. The application hit test 316 determines which portion of the application window or other part of the application user interface the user input corresponds to. The application process 306 performs gesture detection 318 to identify what user interaction (e.g., what gesture) is being input by the user, and determination of whether to handle the user interaction itself or handoff handling of the user interaction to the system process 304. The application process 306 may also determine it needs additional user input to determine whether to handle the user interaction itself or handoff handling of the user interaction to the system process 304, which can be treated as if the application process 306 determines to handle the user interaction itself.

Flow 300 assumes that the application process 306 determines to handoff handling of the user interaction to the system process 304. Thus, an indication 320 of the handoff (e.g., which may be referred to as a capture request) is provided to the system process 304. In response to the indication 320, the system process 304 proceeds to handle 322 the user interaction. This indication to the system process 304 initiates handling of the user interaction by the system process 304 (e.g., the display system module 202).

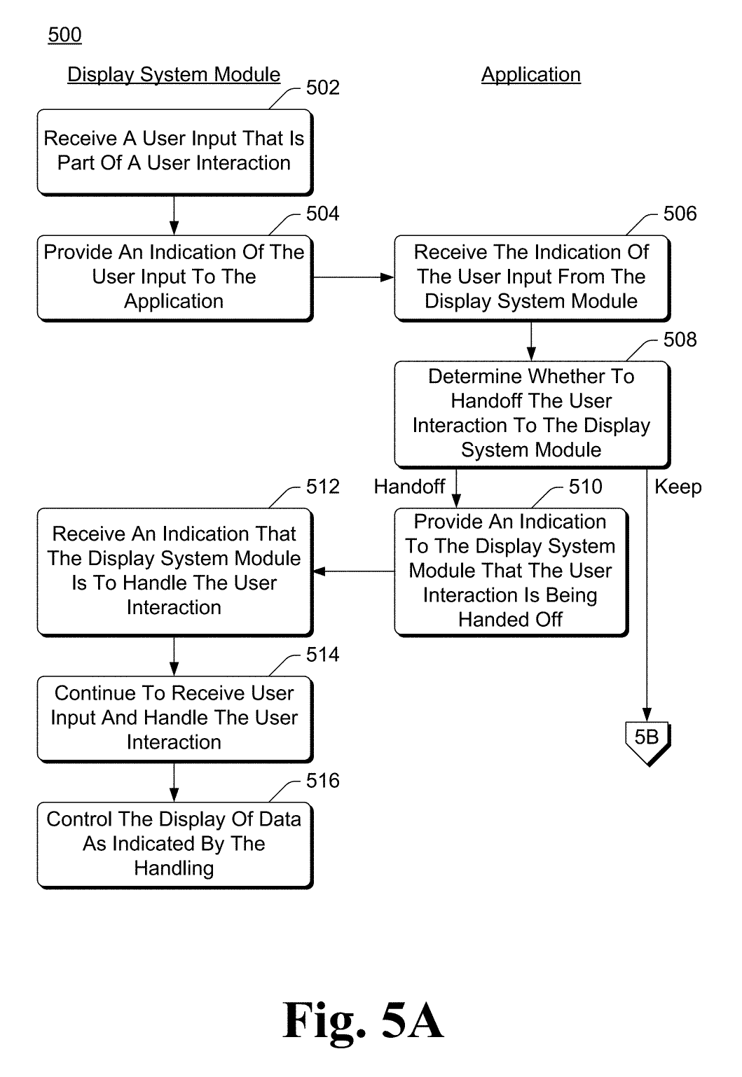

FIG. 4 illustrates an example action flow 400 using the techniques discussed herein. The flow 400 includes actions performed by the hardware and/or input drivers 302 and the system process 304. After initiating handling of the user interaction by the system process 304 (e.g., by the indication 320 of FIG. 3), much of the input flow can be short-circuited. As shown in flow 400, the hardware and/or drivers 302 receive user input 332, which is part of the same user interaction as the user input 312. The user input 332 is provided to the system process 304, which performs a system hit test 334 on the user input. The system hit test 334 determines which application the user input corresponds to (e.g., which window was touched or is currently the active window). The system hit test 334 indicates that the user input corresponds to the application 306, and the system process 304 knows that the system process 304 is handling the current user interaction for the application 306. The system process 304 thus handles the user interaction 336.

Thus, after handling of the user interaction is handed off to the system process 304, the user interaction can be handled completely in the hardware and/or input drivers 302 and the system process 304 without any context switches between the system process 304 to the application process 306, and without waiting for the application 306 to respond to the user input. This improves performance of the computing device, allowing the user interaction to be handled more quickly and reducing the impact on resource usage in the computing device.

As can be seen from the discussion herein (e.g., FIGS. 3 and 4), an operating system has a system process (e.g., referred to as a composition service process) that knows where everything is on the display at any given time. Therefore, that system process hit tests to know where to send the user input. The techniques discussed herein allow, rather than the composition process sending the user input to an application process (and the application process making changes and sending it back to the composition process), the application process to tell the composition process not to send the user input to the application process and to just keep the user input and handle the user interaction within the system process. This reduces overall latency, reduces processor (e.g., CPU) usage, and so forth (e.g., due to reducing the cross-process context switches).

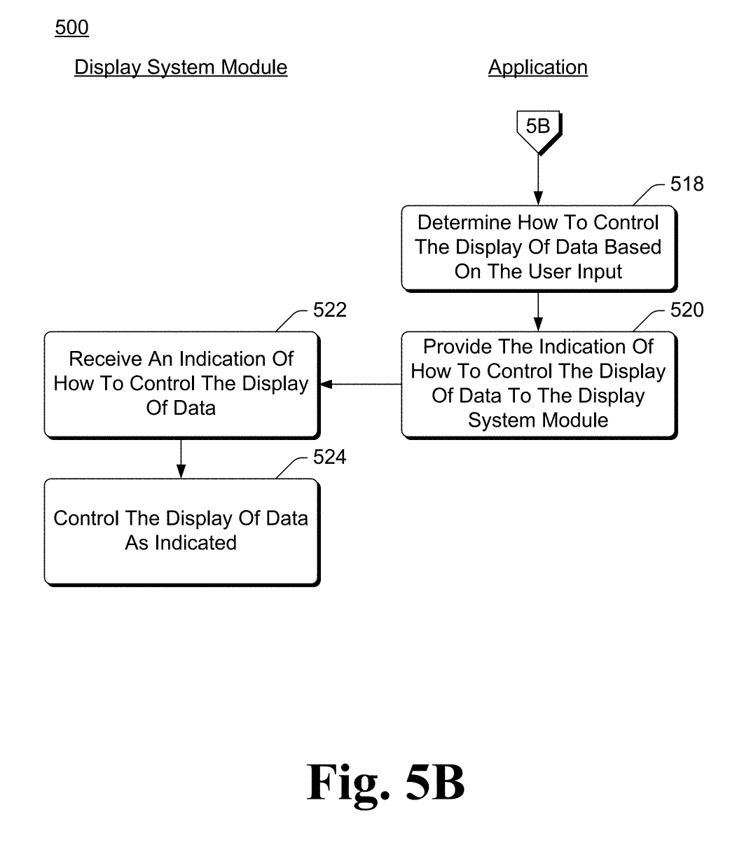

FIGS. 5A and 5B are a flowchart illustrating an example process 500 for asynchronous interaction handoff to system at arbitrary time as discussed herein in accordance with one or more embodiments. Process 500 can be implemented in software, firmware, hardware, or combinations thereof. Acts of process 500 illustrated on the left-hand side of FIGS. 5A and 5B are carried out by a display system module, such as display system module 202 of FIG. 2 or system process 304 of FIG. 3 or FIG. 4. Acts of process 500 illustrated on the right-hand side of FIGS. 5A and 5B are carried out by an application, such as application 106 of FIG. 1 or FIG. 2, or application process 306 of FIG. 3 or FIG. 4. Process 500 is shown as a set of acts and is not limited to the order shown for performing the operations of the various acts. Process 500 is an example process for implementing the asynchronous interaction handoff to system at arbitrary time; additional discussions of implementing the asynchronous interaction handoff to system at arbitrary time are included herein with reference to different figures.

In process 500, a user input that is part of a user interaction is received (act 502). Various different user interaction can be received as discussed above.

An indication of the user input is provided to the application (act 504). This indication can be provided in various manners, such as by invoking an application programming interface (API) of the application, calling or invoking a callback function of the application, sending a message or notification via a messaging system of the operating system of the computing device, and so forth.

The application receives the indication of the user input from the display system module (act 506) and determines whether to handoff the user interaction to the display system module (act 508). The determination of whether to handoff the user interaction to the display system module can be made in various manners as discussed above. The application decides which user interactions are handed off to the display system module, and for each handed off user interaction the application decides when the handoff occurs.

In situations in which the application determines to handoff the user interaction to the display system module, an indication that the user interaction is being handed off to the display system module is provided to the display system module (act 510). The display system module receives the indication that the display system module is to handle the user interaction (act 512) and proceeds to continue to receive user input and handle the user interaction (act 514). Handling the user interaction includes continuing to receive user inputs for the user interaction and determining how to change the display of data. The user input need not be (and typically is not) provided to the application for the remainder of the user interaction.

The display system module proceeds to control the display of data as indicated by the handling (act 516). This control continues for the duration of the user interaction.

Returning to act 508, in situations in which the application determines to keep handling the user interaction rather than handing off the user interaction to the display system module, the application determines how to control the display of data based on the user input (act 518 of FIG. 5B). An indication of how to control the display of data is provided to the display system module (act 520), which receives the indication (act 522). The display system module proceeds to control the display of data as indicated by the application (act 524). E.g., the display system module can change which data is displayed based on the indication received from the application.

Returning to FIG. 2, it should be noted that the application 106 can determine to hand off the user interaction to the display system module 202 at any time during or after the user interaction (at any arbitrary time as desired by the application 106). For example, the application 106 can determine to hand off the user interaction to the display system module 202 in response to the current user interaction being determined by the application 106, in response to the initial user input for the user interaction being received by the application 106 (even though the user interaction has not yet been determined), or alternatively at some other time. By way of another example, the application 106 can determine to hand off the user interaction to the display system module 202 after the user interaction has been completed. The display system module 202 can buffer user input it provides to the application 106 as discussed above, and thus readily handle the user interaction as appropriate given the buffered user input after the user interaction has been completed.

It should also be noted that, in one or more embodiments if the application 106 hands off the user interaction to the display system module 202, the display system module 202 handles all of the user interaction. Alternatively, if the application 106 hands off the user interaction to the display system module 202, the application 106 can determine how to control the display of data and provide the indication of how to control the display of data to the display system module 202 for part of the user interaction and then hand off the user interaction to the display system module 202 so that the display system module 202 handles the remainder of the user interaction.

In one or more embodiments, the application 106 groups user interactions into one of two different categories: one category that the application 106 handles, and another category that the application 106 hands off to the system to handle. Which user interactions are included in which categories can be determined in a variety of different manners as desired by the application 106. For example, user interactions for which the application 106 has custom logic (e.g., desires to be handled in a particular manner, which may be other than a traditional or conventional manner for handling the user interaction) are included in the category that the application 106 handles, but user interactions for which the application 106 does not have custom logic (e.g., a pinch-zoom gesture) are include in the category that the application 106 hands off to the system.

In one or more embodiments, the application 106 provides an indication to the display system module 202 of various configuration parameters for user interactions. These configuration parameters can include, for example, how far to move for a particular gesture (e.g., a scroll or pan speed). Thus, the application 106 can inform the display system module 202, for each user interaction that the display system module 202 handles, various parameters for how to perform that user interaction. This indication can be provided at various times, such as at the time when the application 106 begins running, at the time when the application 106 hands off handling of the user interaction to the display system module, and so forth. These configuration parameters can be provided to the display system module 202, for example, by the application 106 invoking an API exposed by the display system module 202. These configuration parameters can also change over time as desired by the application 106.

Thus, the techniques discussed herein describe the ability for the system to short-circuit the input pipeline and handle interactions asynchronously. This includes initiating the asynchronous interaction at an arbitrary point in the input sequence. The system input handling can be used to drive scrolling or other types of animations. Asynchronous input handling allows smooth interactions regardless of the speed of the application threads. In addition, the techniques discussed herein provide performance benefits by reducing delay both when initiating a system interaction from the beginning of the input sequence (e.g., the beginning of the user interaction), and at an arbitrary point in the input sequence (e.g., the user interaction). Furthermore, the techniques discussed herein provide performance benefits by reducing context switches between processes to handle the input (e.g., the user interaction) because the input is handled by the system (e.g., the display system module 202) rather than the application process.

Using the techniques discussed herein, the application need not be responsible for handling input, detecting gestures, moving their visuals and content, and then committing these changes to the system. Rather, the application process will still receive the user input and then, after user interaction detection for user interactions (e.g., gesture detection for gestures) that the application chooses to have the system compositor (e.g., the display system module 202) handle, the application can order the system to handle the input on their behalf beginning at any arbitrary point in the input sequence. For example, taps can continue to be handled by the application, and pans can be redirected back to the compositor to handle.

After initiating the system input handling, much of the input flow can be short-circuited (e.g., resulting in the flow illustrated in FIG. 4). The interaction can be handled completely in the system without any context switches or waiting for the application to respond.

As an example, the techniques discussed herein can be used for a scenario where the application has custom logic for performing drag operations, but as soon as the application detects a pinch-stretch gesture, the application would like the system to begin handling the gesture. The application thus handles drag operations, but hands off pinch-stretch gesture handling to the operating system.

The techniques discussed herein also allow input to continue flowing to the application in the event that the system does not support handling the current user interaction itself. For example, the tap gesture might not require any system handling, so the input for that gesture could flow through to the application without hurting the performance of any future pan or pinch-stretch interactions that are handled by the system.

The techniques discussed herein also allow smooth operation of user interactions. User interactions can be handled by the display system module and be a smooth process regardless of what other operations the application is performing due to the application being short-circuited and not relied on to handle the user interaction.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

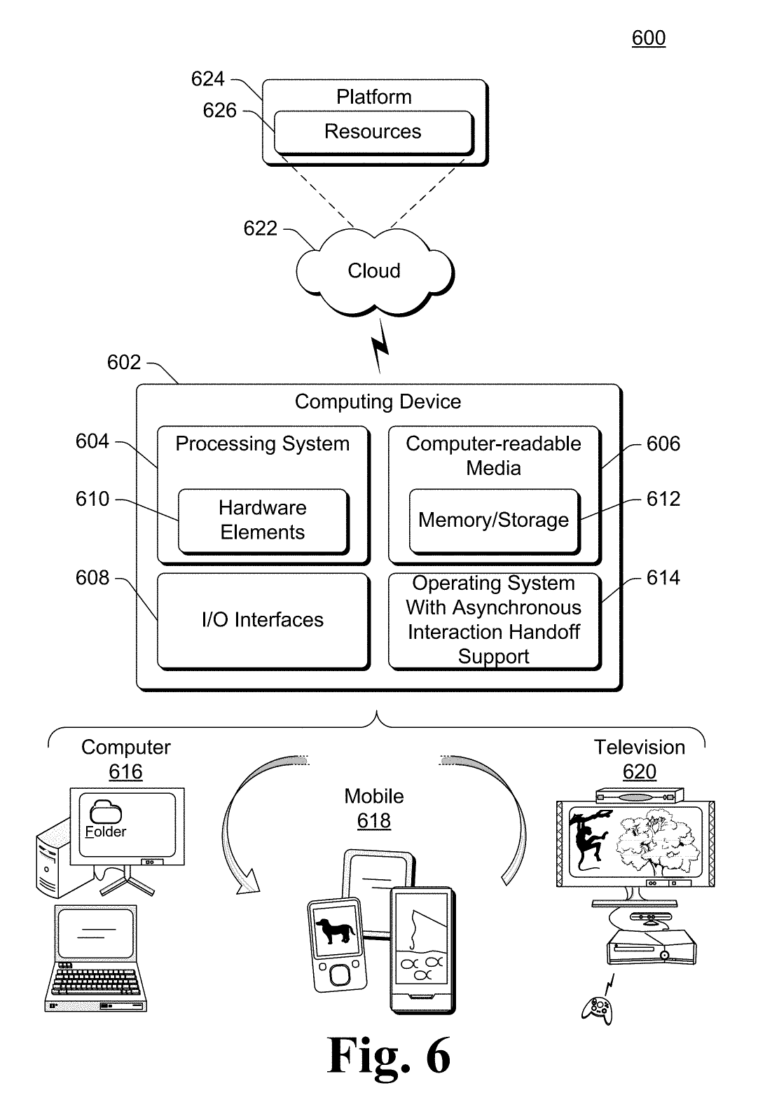

FIG. 6 illustrates an example system generally at 600 that includes an example computing device 602 that is representative of one or more systems and/or devices that may implement the various techniques described herein. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O Interfaces 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware elements 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 606 is illustrated as including memory/storage 612. The memory/storage 612 represents memory/storage capacity associated with one or more computer-readable media. The memory/storage 612 may include volatile media (such as random access memory (RAM)) and/or nonvolatile media (such as read only memory (ROM), Flash memory, optical disks, magnetic disks, and so forth). The memory/storage 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

The one or more input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 602 may be configured in a variety of ways as further described below to support user interaction.

The computing device 602 also includes an operating system with asynchronous interaction handoff support 614. The operating system with asynchronous interaction handoff support 614 provides various user interaction handoff functionality as discussed above. The operating system with asynchronous interaction handoff support 614 can implement, for example, the operating system with asynchronous interaction handoff support 104 of FIG. 1 or FIG. 2.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 610 and computer-readable media 606 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of modules as a module that is executable by the computing device 602 as software may be achieved at least partially in hardware, e.g., through use of computer-readable storage media and/or hardware elements 610 of the processing system. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 602 may assume a variety of different configurations, such as for computer 616, mobile 618, and television 620 uses. Each of these configurations includes devices that may have generally different constructs and capabilities, and thus the computing device 602 may be configured according to one or more of the different device classes. For instance, the computing device 602 may be implemented as the computer 616 class of a device that includes a personal computer, desktop computer, a multi-screen computer, laptop computer, netbook, and so on.

The computing device 602 may also be implemented as the mobile 618 class of device that includes mobile devices, such as a mobile phone, portable music player, portable gaming device, a tablet computer, a multi-screen computer, and so on. The computing device 602 may also be implemented as the television 620 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 622 via a platform 624 as described below.

The cloud 622 includes and/or is representative of a platform 624 for resources 626. The platform 624 abstracts underlying functionality of hardware (e.g., servers) and software resources of the cloud 622. The resources 626 may include applications and/or data that can be utilized while computer processing is executed on servers that are remote from the computing device 602. Resources 626 can also include services provided over the Internet and/or through a subscriber network, such as a cellular or Wi-Fi network.

The platform 624 may abstract resources and functions to connect the computing device 602 with other computing devices. The platform 624 may also serve to abstract scaling of resources to provide a corresponding level of scale to encountered demand for the resources 626 that are implemented via the platform 624. Accordingly, in an interconnected device embodiment, implementation of functionality described herein may be distributed throughout the system 600. For example, the functionality may be implemented in part on the computing device 602 as well as via the platform 624 that abstracts the functionality of the cloud 622.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a system module of a computing device, the method comprising: receiving a first user input to the computing device that is part of a first user interaction with the computing device; providing, to an application on the computing device, an indication of the first user input; receiving, from the application at an arbitrary time during the first user interaction, an indication that the system module is to handle the first user interaction; and in response to receipt of the indication that the system module is to handle the first user interaction: continuing to receive user input for the first user interaction; determining how to change a display of data by the computing device by the system module handling the first user interaction rather than the application handling the first user interaction; and controlling a display of data based on the handling of the first user interaction by the system module.

Alternatively or in addition to any of the above described methods, any one or combination of: the system module continuing to handle the first user interaction for the duration of the first user interaction; the method further comprising receiving a second user input to the computing device that is part of a second user interaction with the computing device, providing, to the application, an indication of the second user input, receiving, from the application, an indication of how to control a display of data for the second user interaction as determined by the application, and controlling the display of data based on the indication of how to control the display of data received from the application; the system module handling user interactions for each of a first category of user interactions, and the application handling user interactions for each of a second category of user interactions; the application determining which user interactions are included in the first category of user interactions and which user interactions are included in the second category of user interactions; the system module handling the first user interaction without performing a context switch to a process of the application for an indication from the application of how to handle the first user interaction; the first user interaction comprising an object down event, an object up event, and object movement that occurs between the object down event and the object up event; the method further comprising buffering the first user input, and the determining how to change the display of data comprising determining how to change the display of data based at least in part on the buffered user input.

A method implemented in an application of a computing device, the method comprising: receiving, from a system module, an indication of a user input to the computing device that is part of a user interaction with the computing device; determining, at an arbitrary time during or after the user interaction, whether to handoff the user interaction to the system module or to keep handling the user interaction; providing, in response to determining to handoff the user interaction to the system module, an indication to the system module that the system module is to handle the user interaction; and in response to determining to keep handling the user interaction: determining how to change a display of data by the computing device based on the user input; and providing an indication of how to change the display of data to the system module.

Alternatively or in addition to any of the above described methods, any one or combination of: the method further comprising, in response to providing the indication to the system module that the system module is to handle the user interaction, receiving no further indications of user input from the system module for the user interaction; the method further comprising receiving, after completion of the user interaction, an indication from the system module of a user input to the computing device that is part of an additional user interaction with the computing device, determining, at an arbitrary time during the additional user interaction, whether to handoff the additional user interaction to the system module or to keep handling the additional user interaction, providing, in response to determining to handoff the additional user interaction to the system module, an indication to the system module that the system module is to handle the additional user interaction, and in response to determining to keep handling the additional user interaction determining how to change a display of data by the computing device based on the user input that is part of the additional user interaction, and providing an indication of how to change the display of data to the system module; the application determining to handoff the user interaction to the system module in response to the user interaction being included in a first category of user interactions, and the application determining to keep handling the user interaction in response to the user interaction being included in a second category of user interactions; the user interaction comprising an object down event, an object up event, and object movement that occurs between the object down event and the object up event.

A computing device comprising: a processor; a computer-readable storage medium having stored thereon multiple instructions of an operating system that, responsive to execution by the processor, cause the processor to: receive a first user input to the computing device that is part of a first user interaction with the computing device; provide, to an application on the computing device, an indication of the first user input; receive, from the application at an arbitrary point during or after the user interaction, an indication that the operating system is to handle the first user interaction; and in response to receipt of the indication that the operating system is to handle the first user interaction: determine how to change a display of data by the computing device by the operating system handling the first user interaction rather than the application handling the first user interaction; and control a display of data based on the handling of the first user interaction by the operating system.

Alternatively or in addition to any of the above described computing devices, any one or combination of the operating system continuing to handle the first user interaction for the duration of the first user interaction; the operating system handling user interactions for each of a first category of user interactions, and the application handling user interactions for each of a second category of user interactions; the application determining which user interactions are included in the first category of user interactions and which user interactions are included in the second category of user interactions; the operating system handling the first user interaction without performing a context switch to a process of the application for an indication from the application of how to handle the first user interaction; the first user interaction comprising an object down event, an object up event, and object movement that occurs between the object down event and the object up event; the multiple instructions further causing the processor to buffer the first user input, and determine how to change the display of data based at least in part on the buffered user input.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a system module of a computing device, the method comprising:
receiving a first user input to the computing device that is part of a first user interaction with the computing device;
providing, to an application on the computing device, an indication of the first user input;
receiving, from the application at an arbitrary time during the first user interaction, an indication that the system module is to handle the first user interaction; and
in response to receipt of the indication that the system module is to handle the first user interaction:
continuing to receive user input for the first user interaction;
determining how to change a display of data by the computing device by the system module handling the first user interaction rather than the application handling the first user interaction; and
controlling a display of data based on the handling of the first user interaction by the system module.

2. The method as recited in claim 1, the system module continuing to handle the first user interaction for the duration of the first user interaction.

3. The method as recited in claim 1, further comprising:
receiving a second user input to the computing device that is part of a second user interaction with the computing device;
providing, to the application, an indication of the second user input;
receiving, from the application, an indication of how to control a display of data for the second user interaction as determined by the application; and
controlling the display of data based on the indication of how to control the display of data received from the application.

4. The method as recited in claim 1, the system module handling user interactions for each of a first category of user interactions, and the application handling user interactions for each of a second category of user interactions.

5. The method as recited in claim 4, the application determining which user interactions are included in the first category of user interactions and which user interactions are included in the second category of user interactions.

6. The method as recited in claim 1, the system module handling the first user interaction without performing a context switch to a process of the application for an indication from the application of how to handle the first user interaction.

7. The method as recited in claim 1, the first user interaction comprising an object down event, an object up event, and object movement that occurs between the object down event and the object up event.

8. The method as recited in claim 1, further comprising:
buffering the first user input; and
the determining how to change the display of data comprising determining how to change the display of data based at least in part on the buffered user input.

9. A method implemented in an application of a computing device, the method comprising:
receiving, from a system module, an indication of a user input to the computing device that is part of a user interaction with the computing device;
determining, at an arbitrary time during or after the user interaction, whether to handoff the user interaction to the system module or to keep handling the user interaction;
providing, in response to determining to handoff the user interaction to the system module, an indication to the system module that the system module is to handle the user interaction; and
in response to determining to keep handling the user interaction:
determining how to change a display of data by the computing device based on the user input; and
providing an indication of how to change the display of data to the system module.

10. The method as recited in claim 9, further comprising, in response to providing the indication to the system module that the system module is to handle the user interaction, receiving no further indications of user input from the system module for the user interaction.

11. The method as recited in claim 10, further comprising:
receiving, after completion of the user interaction, an indication from the system module of a user input to the computing device that is part of an additional user interaction with the computing device;
determining, at an arbitrary time during the additional user interaction, whether to handoff the additional user interaction to the system module or to keep handling the additional user interaction;
providing, in response to determining to handoff the additional user interaction to the system module, an indication to the system module that the system module is to handle the additional user interaction; and
in response to determining to keep handling the additional user interaction:
determining how to change a display of data by the computing device based on the user input that is part of the additional user interaction; and
providing an indication of how to change the display of data to the system module.

12. The method as recited in claim 9, the application determining to handoff the user interaction to the system module in response to the user interaction being included in a first category of user interactions, and the application determining to keep handling the user interaction in response to the user interaction being included in a second category of user interactions.

13. The method as recited in claim 9, the user interaction comprising an object down event, an object up event, and object movement that occurs between the object down event and the object up event.

14. A computing device comprising:
a processor;
a computer-readable storage medium having stored thereon multiple instructions of an operating system that, responsive to execution by the processor, cause the processor to:
receive a first user input to the computing device that is part of a first user interaction with the computing device;
provide, to an application on the computing device, an indication of the first user input;
receive, from the application at an arbitrary point during or after the user interaction, an indication that the operating system is to handle the first user interaction; and
in response to receipt of the indication that the operating system is to handle the first user interaction:
determine how to change a display of data by the computing device by the operating system handling the first user interaction rather than the application handling the first user interaction; and
control a display of data based on the handling of the first user interaction by the operating system.

15. The computing device as recited in claim 14, the operating system continuing to handle the first user interaction for the duration of the first user interaction.

16. The computing device as recited in claim 14, the operating system handling user interactions for each of a first category of user interactions, and the application handling user interactions for each of a second category of user interactions.

17. The computing device as recited in claim 16, the application determining which user interactions are included in the first category of user interactions and which user interactions are included in the second category of user interactions.

18. The computing device as recited in claim 14, the operating system handling the first user interaction without performing a context switch to a process of the application for an indication from the application of how to handle the first user interaction.

19. The computing device as recited in claim 14, the first user interaction comprising an object down event, an object up event, and object movement that occurs between the object down event and the object up event.

20. The computing device as recited in claim 14, the multiple instructions further causing the processor to:
buffer the first user input; and
determine how to change the display of data based at least in part on the buffered user input.
